(19) United States
(12) Patent Application Publication
(10) Pub. No.: US 2023/0274049 A1
(43) Pub. Date: Aug. 31, 2023

(54) DIGITAL TWIN SIMULATION BASED KEY PERFORMANCE INDICATOR SELECTION

(71) Applicant: INTERNATIONAL BUSINESS MACHINES CORPORATION, ARMONK, NY (US)

(72) Inventors: Saraswathi Sailaja Perumalla, Visakhapatnam (IN); Sarbajit K. Rakshit, Kolkata (IN); Trinadh Raja, Visakhapatnam (IN); Randhir Singh, Jammu (IN)

(21) Appl. No.: 17/652,541

(22) Filed: Feb. 25, 2022

(51) Int. Cl. G06F 30/20; G06F 30/12

(52) U.S. Cl. CPC G06F 30/20; G06F 30/12; G06F 2119/02

(57) ABSTRACT

A method, computer system, and a computer program product for manufacturing optimization is provided. The present invention may include, receiving data for one or more physical assets utilized in a manufacturing process. The present invention may include, generating a digital twin, wherein the digital twin includes a digital representation of the one or more physical assets utilized in the manufacturing process. The present invention may include, simulating a performance of the digital twin for the manufacturing process under a plurality of conditions. The present invention may include, analyzing the performance of the digital twin under the plurality of conditions.

### BACKGROUND

The present invention relates generally to the field of computing, and more particularly to digital twins.

Manufacturers and/or other businesses may employ individuals who may work with physical assets within a physical ecosystem. Physical assets may include, but are not limited to including, turning machines, shapers and/or planers, drilling machines, milling machines, grinding machines, power saws, presses, various robotic systems, amongst other industrial machines.

Manufacturers and/or other business may utilize Key Performance Indicators (KPIs) and/or other metrics in at least, gauging the performance of the physical assets over time, identifying bottlenecks in a manufacturing process, monitoring health conditions of physical assets, and/or reasoning in informed decision making.

### SUMMARY

Embodiments of the present invention disclose a method, computer system, and a computer program product for manufacturing optimization utilizing digital twins. The present invention may include, receiving data for one or more physical assets utilized in a manufacturing process. The present invention may include, generating a digital twin, wherein the digital twin includes a digital representation of the one or more physical assets utilized in the manufacturing process. The present invention may include, simulating a performance of the digital twin for the manufacturing process under a plurality of conditions. The present invention may include, analyzing the performance of the digital twin under the plurality of conditions.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for manufacturing optimization according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for manufacturing optimization. As such, the present embodiment has the capacity to improve the technical field of digital twins by generating a digital twin for each manufacturing process. More specifically, the present invention may include, receiving data for one or more physical assets utilized in a manufacturing process. The present invention may include, generating a digital twin, wherein the digital twin includes a digital representation of the one or more physical assets utilized in the manufacturing process. The present invention may include, simulating a performance of the digital twin for the manufacturing process under a plurality of conditions. The present invention may include, analyzing the performance of the digital twin under the plurality of conditions.

As described previously, manufacturers and/or other businesses may employ individuals who may work with physical assets within a physical ecosystem. Physical assets may include, but are not limited to including, turning machines, shapers and/or planers, drilling machines, milling machines, grinding machines, power saws, presses, various robotic systems, amongst other industrial machines.

Manufacturers and/or other business may utilize Key Performance Indicators (KPIs) and/or other metrics in at least, gauging the performance of the physical assets over time, identifying bottlenecks in a manufacturing process, monitoring health conditions of physical assets, and/or reasoning in informed decision making.

Therefore, it may be advantageous to, among other things, receive data for one or more physical assets utilized in a manufacturing process, generate a digital twin, wherein the digital twin includes a digital representation of the one or more physical assets utilized in the manufacturing process, simulate a performance of the digital twin for the manufacturing process under a plurality of conditions, and analyze the performance of the digital twin under each of the plurality of conditions.

According to at least one embodiment, the present invention may improve the identification of potential bottlenecks and/or issues with respect to a manufacturing process by comparing Key Performance Indicators (KPIs) from simulations in which a digital twin failed non-functional and/or functional requirements with simulations in which the digital twin achieved non-functional and/or functional requirements. Furthermore, this may enable a user to monitor only the KPIs required for each physical asset utilized in the manufacturing process.

According to at least one embodiment, the present invention may improve the ability of manufacturers and/or other business to make decisions with respect to manufacturing process by enabling the user to manually select in a user interface the plurality of conditions by which a digital twin representing a manufacturing process may be simulated.

According to at least one embodiment, the present invention may improve the manufacturing process of a manufacturer and/or business by providing one or more recommendations based on at least the simulated KPIs of a digital twin representing the manufacturing process under a plurality of conditions. The one or more recommendations may include, but are not limited to including, installation of more IoT devices, adjustment to production volume, utilization of production downtime, reduction of production costs recommendations to improve physical asset effectiveness, recommendations to meet functional and/or non-functional requirements, physical asset upkeep, amongst other recommendations which may improve the manufacturing process.

According to at least one embodiment, the present invention may improve the ability of manufacturers and/or other businesses to proactively improve and/or maintain physical assets utilized in a manufacturing process by monitoring the physical ecosystem which may be comprised of all the physical assets utilized in one or more manufacturing processes. The invention may monitor the physical ecosystem utilizing real time data received from at least, one or more IoT devices, images and/or scans of the physical ecosystem and/or each physical asset, data received from the user, amongst other real time data which may be utilized in updating the digital twin of each manufacturing process.

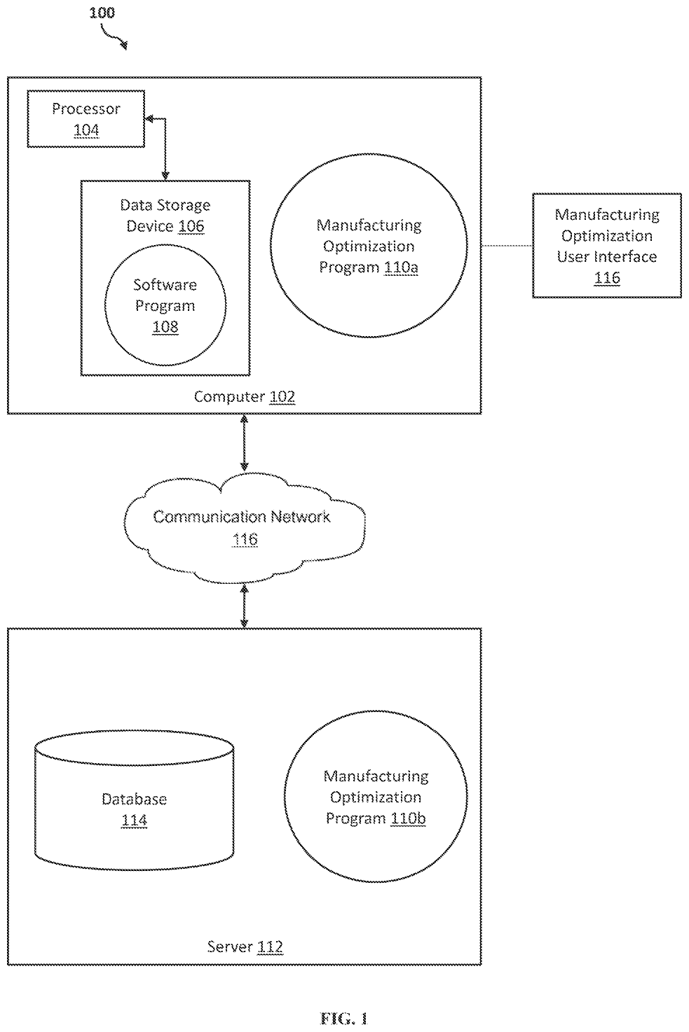

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a manufacturing optimization program 110a. The networked computer environment 100 may also include a server 112 that is enabled to run a manufacturing optimization program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

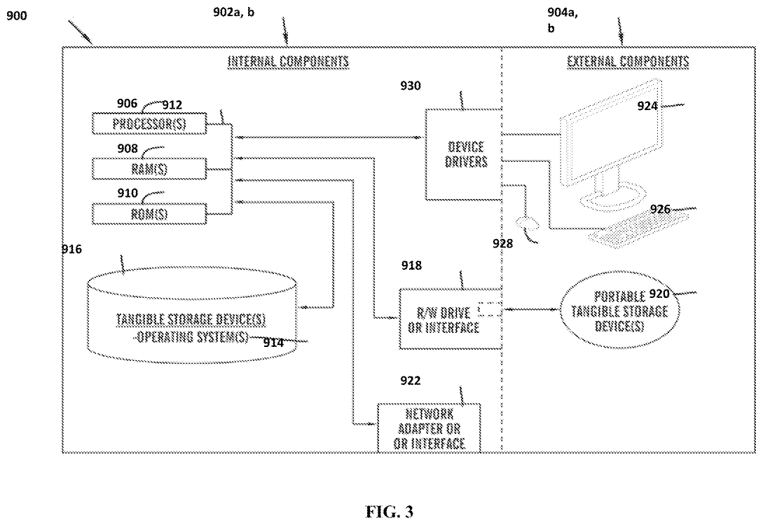

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the manufacturing optimization program 110a, 110b may interact with a database 114 that may be embedded in various storage devices, such as, but not limited to a computer/mobile device 102, a networked server 112, or a cloud storage service.

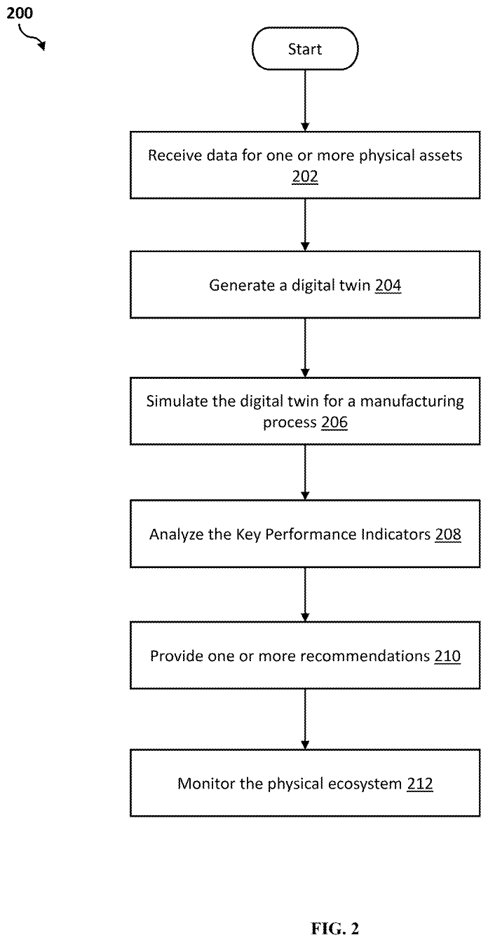

According to the present embodiment, a user using a client computer 102 or a server computer 112 may use the manufacturing optimization program 110a, 110b (respectively) to simulate each manufacturing process of an industrial floor while monitoring Key Performance Indicators, non-functional requirements, and/or functional requirements. The manufacturing optimization method is explained in more detail below with respect to FIG. 2.

Referring now to FIG. 2, an operational flowchart illustrating the exemplary manufacturing optimization process 200 used by the manufacturing optimization program 110a and 110b (hereinafter manufacturing optimization process 110) according to at least one embodiment is depicted.

At 202, the manufacturing optimization program 110 receives data for one or more physical assets utilized in a manufacturing process. A physical ecosystem may be comprised of a plurality of physical assets responsible for one or more manufacturing processes. The physical ecosystem may be an industrial floor, warehouse, manufacturing plant, and/or other factory. The physical assets may include, but are not limited to including, turning machines, shapers and/or planers, drilling machines, milling machines, grinding machines, power saws, presses, various robotic systems, amongst other industrial machines. The physical assets comprising the physical ecosystem may be operated by one or more individuals. The one or more individuals may perform one or more activities utilizing the physical assets in performing a manufacturing process.

The manufacturing optimization program 110 may receive and/or access data for each of the one or more physical assets utilized in each manufacturing process conducted in the physical ecosystem. For example, Machine 1, Machine 2, and Machine 3 may be utilized in the manufacturing of rubber insoles while Machine 4, Machine 5, and Machine 6 may be utilized in the manufacturing of rubber outsoles. In this example, as will be explained in more detail below with respect to step 204, the manufacturing optimization program 110 may generate a digital twin for the machines utilized in manufacturing the rubber insoles and/or generate a digital twin for the machines utilized in manufacturing the rubber outsoles.

The manufacturing optimization program 110 may receive and/or access data for each of the plurality of physical assets of the physical ecosystem. A user may designate within a manufacturing optimization user interface 118 which of the plurality of physical assets may be utilized in a manufacturing process. The manufacturing optimization program 110 may receive and/or access data with respect to the plurality of physical assets comprising the physical ecosystem from a user, one or more Internet of Things (IoT) devices, images and/or 3D scans of the physical ecosystem and/or physical assets, smart wearable devices associated with the individuals operating the physical assets, one or more publicly available resources, amongst other methods of receiving and/or accessing data. The user may provide data to the manufacturing optimization program 110 in the manufacturing optimization user interface 118. The manufacturing optimization user interface 118 may be displayed by the manufacturing optimization program 110 in at least, an internet browser, dedicated software application, and/or as an integration with a third party software application. The manufacturing optimization program 110 may store the data received and/or accessed with respect to the physical ecosystem and/or physical assets comprising the physical ecosystem in a knowledge corpus (e.g., database 114). As will be explained in more detail below, the manufacturing optimization program 110 may continuously update and/or add data to the knowledge corpus (e.g., database 114) based on real time data received. The data stored in the knowledge corpus (e.g., database 114) may be utilized in generating and/or monitoring Key Performance Indicators (KPIs) for each of the one or more physical assets utilized in a manufacturing process.

The manufacturing optimization program 110 may receive and/or access data for each of the plurality of physical assets utilized in the manufacturing process. Data received and/or accessed by the manufacturing optimization program 110 with respect to the physical assets comprising the physical ecosystem may include, but are not limited to including, data from the physical assets, data from Internet of Things (IoT) devices associated with the physical assets, images, videos, and/or 3D scans of the physical assets received from a camera of the one or more IoT devices, a brand, model number, bill of materials, product codes, part numbers, design specifications, production processes, engineering information, material composition of parts, amongst other data for the physical assets. The manufacturing optimization program 110 may also receive data from the user with respect to, functional requirements, non-functional requirements, maintenance/upkeep, operating conditions, health of the machine and/or machine components, hours the machine is utilized per day, usage patterns, structural health, amongst other data. The manufacturing optimization program 110 may utilize at least, the data received from physical assets, images, videos, and/or 3D scans of the physical assets received from the camera of the one or more IoT devices, amongst other data received and/or accessed in monitoring the functional and/or non-functional requirements of the product which may be produced by the manufacturing process.

Functional requirements may be requirements which specify what a manufacturing process should do. Functional requirements may include, but are not limited to including, product features, quality requirements, amongst other functional requirements. Non-functional requirements may specify how a manufacturing process performs a specific function. Non-functional requirements may include, but are not limited to including, quality of a work product, time required to complete a work product, product properties, client expectations, machine and/or physical asset health, amongst other non-functional requirements. Functional and/or non-functional requirements may be specified by the user in the manufacturing optimization user interface 118. As will be explained in more detail below, the functional and/or non-functional requirements of a product may impact the KPIs which require monitoring for each physical asset of the manufacturing process. For example, wax may be selected as the raw material to be utilized in the production of a prototypical model of a product. Wax may melt under a comparatively low temperature when compared to metal. Accordingly, the utilization of wax in a manufacturing process may necessitate the KPI for temperature be monitored for the physical assets utilized in the manufacturing process. However, if metal is selected as the raw material to be utilized in the production of a prototypical model for a product the KPI for temperature may not be monitored for the physical assets utilized in the manufacturing process.

The manufacturers and/or other businesses which may employ the one or more individuals operating the physical assets comprising the physical ecosystem may utilize Key Performance Indicators (KPIs) and/or other metrics in at least, gauging the performance of the physical assets over time, identifying bottlenecks in a manufacturing process, monitoring health conditions of the physical assets, and/or reasoning informed decision making. KPIs utilized by the manufacturers and/or other businesses may include, but are not limited to including, heat generated by a physical asset, vibration and/or movement during a manufacturing process of a physical asset, air quality of the physical ecosystem in which the manufacturing process occurs, rotational speed of one or more components of the physical asset, production volume, production downtime, production costs, overall operations effectiveness, overall equipment effectiveness, total effective equipment performance, capacity utilization, defect density, rate of return, on-time delivery, asset turnover, unit costs, return on assets, maintenance costs, amongst other KPIs which may be monitored. As will be explained in more detail below with respect to at least steps 206 and 208, the manufacturing optimization program 110 may monitor and/or analyze the KPIs for the one or more physical assets utilized in a manufacturing process based on simulations of a digital twin representing the one or more physical assets for the manufacturing process.

The manufacturing optimization program 110 may utilize an Artificial Intelligence (AI) system in determining the one or more steps of each of the one or more manufacturing processes performed by the plurality of physical assets of the physical ecosystem. The AI system may determine the one or more steps for each of the one or more manufacturing processes based on at least the data stored in the knowledge corpus (e.g., database 114).

The manufacturing optimization program 110 may also receive data with respect to the physical ecosystem. Data received and/or accessed by the manufacturing optimization program 110 with respect to the physical ecosystem may include, but is not limited to including, square footage, property size, location, material used in construction, window types, year built, blueprints, roofing details, architecture, information on appliances, occupancy, ventilation systems, airflow details, as well as real time data from one or more IoT devices associated with the physical ecosystem. The one or more IoT devices associated with the physical ecosystem may include, but are not limited to including, thermostats, lighting, air quality, smoke detectors, carbon monoxide detectors, irrigations systems, security, air conditioning, movement, and ventilation systems, amongst other IoT devices. The one or more IoT devices may perform readings of the environment within the physical ecosystem. The IoT devices may be connected to one or more sensors (e.g., temperature sensors, motion sensors, humidity sensors, pressure sensors, accelerometers, gas sensors, multi-purpose IoT sensors, amongst other sensors) to perform the one or more readings. The data from the one or more readings performed by the IoT devices may be stored on the IoT device itself and/or broadcasted to the knowledge corpus (e.g., database 114). Data received and/or accessed by the manufacturing optimization program 110 with respect to the physical ecosystem may utilized in generating a digital twin in which the physical assets comprising the physical ecosystem may be orientated such that the digital representation represents the industrial floor, warehouse, manufacturing plant, and/or other factory.

At 204, the manufacturing optimization program 110 generates a digital twin. The manufacturing optimization program 110 may generate a digital twin for each of the one or more manufacturing processes conducted in the physical ecosystem. The digital twin may be comprised of the one or more physical assets of the physical ecosystem utilized in a manufacturing process. A digital twin may be a digital representation of at least an object, entity, and/or system that spans the object, entity, and/or system's lifecycle. The digital twin may be updated using real time data, and may utilize, at least, simulation, machine learning, and/or reasoning in aiding informed decision making.

The manufacturing optimization program 110 may utilize the digital twin in simulating the KPIs for each of the physical assets in a manufacturing process. As will be explained in more detail below with respect to step 206, the manufacturing optimization program 110 may utilize the digital twin in identifying bottlenecks and/or other issues with a manufacturing process. The digital twin may be updated in real time based on at least real time data received from at least, the one or more IoT devices, smart wearable devices, and/or other real time data received with respect to the physical assets of the manufacturing process.

For example, the physical ecosystem may be an industry floor comprised of 9 industrial machines. Machines 1, 2, and 3 may be utilized for Manufacturing Process 1. Machines 4, 5, and 6 may be utilized for Manufacturing Process 2. Machines 7, 8, and 9 may be utilized for Manufacturing Process 3. The manufacturing optimization program 110 may generate 3 digital twins, Digital Twin 1 corresponding to Manufacturing Process 1, Digital Twin 2 corresponding to Manufacturing Process 2, and Digital Twin 3 corresponding to Digital Twin 3. As will be explained in more detail below, the manufacturing optimization program 110 may simulate the performance of each digital twin including the KPIs under a plurality of conditions. The plurality of conditions may be based on at least the data stored in the knowledge corpus (e.g., database 114), the functional requirements of the manufacturing process, and/or the non-functional requirements of the manufacturing process.

At 206, the manufacturing optimization program 110 simulates the performance of the digital twin for a corresponding manufacturing process in a plurality of conditions. The manufacturing optimization program 110 may simulate the performance of the digital twin in a plurality of conditions based on at least the data stored in the knowledge corpus (e.g., database 114), the functional requirements of the corresponding manufacturing process, and the non-functional requirements of the corresponding manufacturing process.

The manufacturing optimization program 110 may utilize one or more machine learning models and/or one or more simulation models in simulating the performance of the digital twin for the corresponding manufacturing process in the conditions. The one or more machine learning models may include, but are not limited to including, Convolutional Neural Networks (CNNs), Artificial Neural Networks (ANNs), Support Vector Machine (SVM), K-Nearest Neighbors (KNN), Naïve Bayes, and/or a hybrid model. The one or more simulation methods may include, but are not limited to including, a Monte Carlo simulation process, agent based simulation model, discrete event simulation model, and/or a system dynamic simulation models, amongst other simulation methods. The industrial safety program 110 may additionally utilize a statistical program such as IBM's SPSS® (SPSS® and all SPSS-based trademarks are trademarks or registered trademarks of International Business Machines Corporation in the United States, and/or other countries), or Statistical Product and Service Solution, in optimizing the one or more simulation methods.

The manufacturing optimization program 110 may determine the conditions in which the digital twin may be simulated based on at least the data stored in the knowledge corpus (e.g., database 114), the functional requirements of the corresponding manufacturing process, and the non-functional requirements of the corresponding manufacturing process, and/or real time data received from the one or more IoT devices, images and/or 3D scans of the physical ecosystem and/or physical assets, smart wearable devices associated with the individuals operating the physical asset, amongst other real time data. The manufacturing optimization program 110 may vary the conditions of the physical ecosystem based on data received at step 202 as well as data accessed from one or more publicly available resources with respect to the real world location of the physical ecosystem, such that the manufacturing process may be simulated for different seasons and/or environmental conditions based on the real world location.

The manufacturing optimization program 110 may simulate at least the KPIs for each of the one or more machines utilized in the corresponding manufacturing process. As will be explained in more detail below with respect to step 208, the manufacturing optimization program 110 may analyze the KPIs for simulations under each of the plurality of conditions in at least identifying bottlenecks and/or other issues which may be inhibiting functional and/or non-functional requirements of the manufacturing process. The manufacturing optimization program 110 may display the simulated KPIs under each of the plurality of conditions in the manufacturing optimization user interface 118. The manufacturing optimization program 110 may utilize unique colors, numbers, flags, and/or other visual representations to represent KPIs which may be inhibiting functional and/or non-functional requirements of the manufacturing process.

The manufacturing optimization program 110 may also simulate the digital for a corresponding manufacturing process based on conditions manually input by the user. The user may manually input the conditions for which the manufacturing optimization program 110 may simulate the digital twin for the corresponding manufacturing process in the manufacturing optimization user interface 118. For example, a user may be performing a manufacturing process on an industrial floor 6 hours per day with 3 machines produces 100 widgets. The 100 widgets produced by the manufacturing process 6 hours a day with the 3 machines meeting the functional and/or non-functional requirements of the manufacturing process and none of the KPIs for the 3 machines may be flagged. The user may enter within the manufacturing optimization user interface 118 conditions such as, the machines operating 10 hours a day, producing 150 widgets, the addition of a 4th machine, amongst other conditions the user wishes to simulate. In this example, the manufacturing optimization program 110 may enable the user to compare the KPIs for the machines operating 6 hours per day versus 10 hours per day, the functional and/or non-functional requirements of 100 widgets versus producing 150 widgets, and/or the manufacturing process if a 4th machine were to be added. The manufacturing optimization program 110 may display the simulation comparisons which may include KPIs for each of the one or more machines utilized in the manufacturing process.

In an embodiment, the manufacturing optimization program 110 may generate a digital twin representative of the physical ecosystem and two or more manufacturing processes. In this embodiment, the manufacturing optimization program 110 may simulate multiple manufacturing processes each performed utilizing one or more physical assets simultaneously. In this embodiment, the manufacturing optimization program 110 may provide recommendations with respect to at least physical asset optimization. For example, the physical ecosystem may be comprised of 8 machines with 4 machines utilized in Manufacturing Process 1 and 4 machines utilized in Manufacturing Process 2. Based on the simulation of both Manufacturing Process 1 and Manufacturing Process 2 simultaneously the manufacturing optimization program 110 may identify KPIs within Manufacturing Process 1 indicating low equipment effectiveness and KPIs within Manufacturing Process 2 indicating high production downtime for 1 of the 4 machines. The manufacturing optimization program 110 may reassign a machine from Manufacturing Process 2 to Manufacturing Process 1 and re-simulate the Manufacturing Process 1 with 5 machines and Manufacturing Process 2 with 3 machines. As will be explained in more detail below with respect to step 210, the manufacturing optimization program 110 may provide recommendations to the user with respect to physical asset optimization.

At 208, the manufacturing optimization program 110 analyzes the performance of the digital twin under the plurality of conditions for the corresponding manufacturing process. The manufacturing optimization program 110 may utilize the KPIs from each of the simulations in performing a Root Cause Analysis (RCA). The manufacturing optimization program 110 may utilize RCA in determining the KPIs which may be the root cause in the simulations of the digital twin in which the manufacturing process failed non-functional and/or functional requirements.

The manufacturing optimization program 110 may utilize one or more RCA tools, including, but not limited to, pareto charts, fishbone diagrams, scatter diagrams, Failure Mode and Effects Analysis (FMEA), amongst other RCA tools. The manufacturing optimization program 110 may utilize a two-step approach in analyzing the KPIs which may include fault domain isolation and/or impacted component analysis. Fault domain isolation may involve identifying a physical asset, specific KPI, and/or component of the physical asset which may be causing a bottleneck and/or inhibiting functional and/or non-functional requirements of the manufacturing process. Impacted component analysis may include analyzing data stored in the knowledge corpus (e.g., database), comparing KPIs from simulations in which the digital twin failed non-functional and/or functional requirements with simulations in which the digital twin achieved non-functional requirements, amongst other factors which may be analyzed under the impacted component analysis. The manufacturing optimization program 110 may also utilize one or more machine learning models in classifying each of the KPIs as required monitoring or inessential monitoring. The one or more machine learning models may utilize at least one or more binary classification methods, such as, but not limited to, support vector machines, naïve bayes, nearest neighbor, decision trees, logistic regression, and/or neural networks, amongst other binary classification models.

The manufacturing optimization program 110 may generate a dynamic dashboard within the manufacturing optimization user interface 118 based on the one or more KPIs which may require monitoring for each physical asset utilized in the manufacturing process. The dynamic dashboard may enable the user to monitor each of the one or more KPIs for each physical asset in the manufacturing process and/or KPIs for the entire manufacturing process.

At 210, the manufacturing optimization program 110 provides one or more recommendations based on at least the simulated KPIs of the digital twin under the plurality of conditions. The manufacturing optimization program 110 may display the one or more recommendations to the user in the manufacturing optimization user interface 118, to a smart wearable device associated with the user, and/or to another device associated with the user and/or individual operating a physical asset as a notification, text message, email, and/or other notification method.

The manufacturing optimization program 110 may provide recommendations such as, but not limited to, installation of more IoT devices, adjustment to production volume, utilization of production downtime, order reminders for replacement parts and/or raw materials, reduction of production costs recommendations to improve physical asset effectiveness, recommendations to meet functional and/or non-functional requirements, physical asset upkeep, changes to the physical ecosystem which may impact KPIs for physical assets utilized in the manufacturing process, supplementation of different raw materials into the manufacturing process, amongst other recommendations which may improve the manufacturing process. The one or more recommendations may be based on the KPIs which require monitoring. The one or more recommendations may be provided by the manufacturing optimization program 110 to improve KPI measurements for those which are determined to require monitoring based on the analysis performed at step 208. The manufacturing optimization program 110 may simulate the one or more recommendations prior to providing the recommendations to the user.

The manufacturing optimization program 110 may display the one or more recommendations to the user in the manufacturing optimization user interface 118. The manufacturing optimization program 110 may display the one or more recommendations in order of improved KPI measurements, wherein the improved KPI measurements may be based on simulating the one or more recommendations prior to displaying the recommendations to the user. The manufacturing optimization program 110 may enable the user to select one or more recommendations within the manufacturing optimization user interface 118 and display a simulation of the physical ecosystem with the one or more recommendations implemented.

At 212, the manufacturing optimization program 110 monitors the physical ecosystem. The manufacturing optimization program 110 may monitor each manufacturing process of the physical ecosystem utilizing the digital twin. The manufacturing optimization program 110 may utilize data received from at least, the one or more IoT devices, images and/or 3D scans of the physical ecosystem and/or each physical asset, smart wearable data from an operator of a physical asset, data received from the user in the manufacturing optimization user interface 118, amongst other real time data in updating the digital twin of each manufacturing process.

The manufacturing optimization program 110 may continuously simulate the digital twin for each of the one or more manufacturing processes based on the real time data received. The manufacturing optimization program 110 may update each digital twin utilizing the real time data and display the updated physical ecosystem to the user within the manufacturing optimization user interface 118. The manufacturing optimization program 110 may also provide at least, additional recommendations, real time alerts, and/or projected KPIs to the user based on the simulations.

In an embodiment, the manufacturing optimization program 110 may also monitor, supply chain factors, raw material prices, physical asset updates, and/or feedback from a client. In an embodiment, the manufacturing optimization program 110 may received feedback from the client with respect to at least functional and/or non-functional requirements of the product produced by the manufacturing process. The manufacturing optimization program 110 may receive feedback from the client directly in the manufacturing optimization user interface 118. In this embodiment, the manufacturing optimization program 110 may utilize the feedback received from the client in providing additional recommendations to the user with respect to optimizing at least the functional and/or non-functional requirements of the product produced by the manufacturing process. The manufacturing optimization program 110 may include details with the additional recommendations such as the cost of implementation and/or details with respect to how the manufacturing process may require alteration. The cost of the recommendation, projected implementation time, amongst other details of the recommendation selected by the user may transmitted by the manufacturing optimization program 110 to the client and displayed in the manufacturing optimization user interface 118.

It may be appreciated that FIG. 2 provides only an illustration of one embodiment and do not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 3. Each of the sets of internal components 902a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the manufacturing optimization program 110a in client computer 102, and the manufacturing optimization program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the manufacturing optimization program 110a and 110b can be stored on one or more of the respective portable computer-readable tangible storage devices 920, read via the respective RAY drive or interface 918 and loaded into the respective hard drive 916.

Each set of internal components 902a, b may also include network adapters (or switch port cards) or interfaces 922 such as a TCP/IP adapter cards, wireless wi-fi interface cards, or 3G or 4G wireless interface cards or other wired or wireless communication links. The software program 108 and the manufacturing optimization program 110a in client computer 102 and the manufacturing optimization program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the manufacturing optimization program 110a in client computer 102 and the manufacturing optimization program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

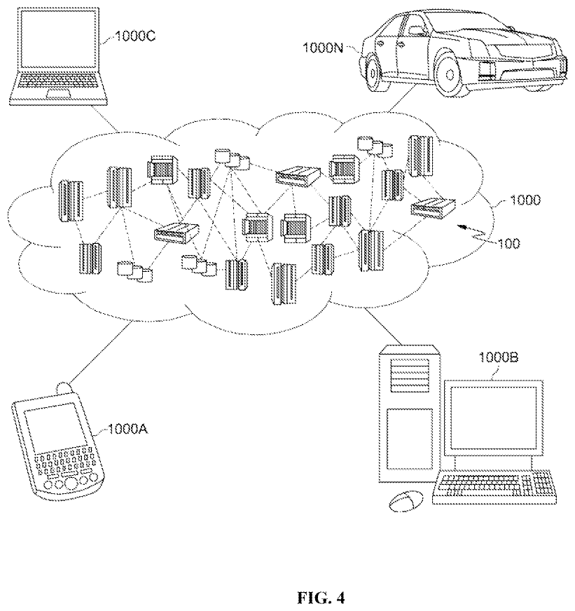

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

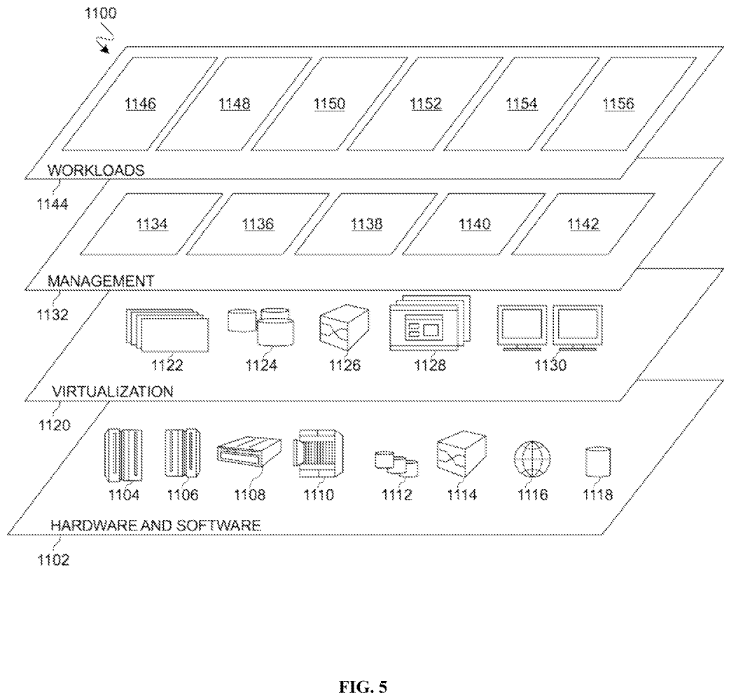

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and manufacturing optimization program 1156. A manufacturing optimization program 110a, 110b provides a way to simulate the performance of one or more physical assets utilized in a manufacturing process to monitor Key Performance Indicators.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for manufacturing optimization, the method comprising:
receiving data for one or more physical assets utilized in a manufacturing process;
generating a digital twin, wherein the digital twin includes a digital representation of the one or more physical assets utilized in the manufacturing process;
performing a plurality of simulations using the digital twin, wherein each simulation of the digital twin simulates the manufacturing process under a plurality of conditions; and
analyzing the performance of the digital twin under each of the plurality of conditions.

2. The method of claim 1, wherein analyzing the performance of the digital twin further comprises:
comparing key performance indicators for the plurality of simulations, wherein the key performance indicators are compared for one or more simulations of the plurality of simulations in which the digital twin failed to meet requirements with one or more simulations of the plurality of simulations in which the digital twin met the requirements; and
identifying the key performance indicators which require monitoring for each of the one or more physical assets.

3. The method of claim 2, wherein the key performance indicators which require monitoring are identified using a root cause analysis.

4. The method of claim 2, wherein the key performance indicators which require monitoring are displayed to a user in a manufacturing optimization user interface.

5. The method of claim 1, wherein the plurality of conditions are manually selected by a user within a manufacturing optimization user interface.

6. The method of claim 1, further comprising:
providing one or more recommendations to user based on the analysis of the digital twin under each of the plurality of conditions.

7. The method of claim 1, further comprising:
receiving real time data from one or more IoT devices associated with the manufacturing process;
updating the digital twin and the plurality of conditions;
simulating an updated digital twin in an updated plurality of conditions; and
providing one or more recommendations to a user based on the simulation of the updated digital twin.

8. A computer system for manufacturing optimization, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving data for one or more physical assets utilized in a manufacturing process;
generating a digital twin, wherein the digital twin includes a digital representation of the one or more physical assets utilized in the manufacturing process;
performing a plurality of simulations using the digital twin, wherein each simulation of the digital twin simulates the manufacturing process under a plurality of conditions; and
analyzing the performance of the digital twin under each of the plurality of conditions.

9. The computer system of claim 8, wherein analyzing the performance of the digital twin further comprises:
comparing key performance indicators for the plurality of simulations, wherein the key performance indicators are compared for one or more simulations of the plurality of simulations in which the digital twin failed to meet requirements with one or more simulations of the plurality of simulations in which the digital twin met the requirements; and
identifying the key performance indicators which require monitoring for each of the one or more physical assets.

10. The computer system of claim 9, wherein the key performance indicators which require monitoring are identified using a root cause analysis.

11. The computer system of claim 9, wherein the key performance indicators which require monitoring are displayed to a user in a manufacturing optimization user interface.

12. The computer system of claim 8, wherein the plurality of conditions are manually selected by a user within a manufacturing optimization user interface.

13. The computer system of claim 8, further comprising:
providing one or more recommendations to user based on the analysis of the digital twin under each of the plurality of conditions.

14. The computer system of claim 8, further comprising:
receiving real time data from one or more IoT devices associated with the manufacturing process;
updating the digital twin and the plurality of conditions;
simulating an updated digital twin in an updated plurality of conditions; and
providing one or more recommendations to a user based on the simulation of the updated digital twin.

15. A computer program product for manufacturing optimization, comprising:
one or more non-transitory computer-readable storage media and program instructions stored on at least one of the one or more tangible storage media, the program instructions executable by a processor to cause the processor to perform a method comprising:
receiving data for one or more physical assets utilized in a manufacturing process;
generating a digital twin, wherein the digital twin includes a digital representation of the one or more physical assets utilized in the manufacturing process;
performing a plurality of simulations using the digital twin, wherein each simulation of the digital twin simulates the manufacturing process under a plurality of conditions; and
analyzing the performance of the digital twin under each of the plurality of conditions.

16. The computer program product of claim 15, wherein analyzing the performance of the digital twin further comprises:
comparing key performance indicators for the plurality of simulations, wherein the key performance indicators are compared for one or more simulations of the plurality of simulations in which the digital twin failed to meet requirements with one or more simulations of the plurality of simulations in which the digital twin met the requirements; and
identifying the key performance indicators which require monitoring for each of the one or more physical assets.

17. The computer program product of claim 16, wherein the key performance indicators which require monitoring are identified using a root cause analysis.

18. The computer program product of claim 16, wherein the key performance indicators which require monitoring are displayed to a user in a manufacturing optimization user interface.

19. The computer program product of claim 15, wherein the plurality of conditions are manually selected by a user within a manufacturing optimization user interface.

20. The computer program product of claim 15, further comprising:
providing one or more recommendations to user based on the analysis of the digital twin under each of the plurality of conditions.
